(19) United States
(12) Patent Application Publication
(10) Pub. No.: US 2016/0142801 A1
(43) Pub. Date: May 19, 2016

(54) FLEXIBLE ELECTROACOUSTIC APPARATUS AND WEARABLE ELECTRONIC PRODUCT CAPABLE OF PROCESSING AUDIO SIGNALS USING THE SAME

(71) Applicant: APTOS TECHNOLOGY INC., Hsin-Chu (TW)

(72) Inventors: Daniel Jow, Hsin-Chu (TW); Yue-Shih Jeng, Hsin-Chu (TW)

(21) Appl. No.: 14/940,157

(22) Filed: Nov. 13, 2015

Related U.S. Application Data
(60) Provisional application No. 62/079,033, filed on Nov. 13, 2014.

(51) Int. Cl. H04R 1/02

(52) U.S. Cl. CPC H04R 1/026

(57) ABSTRACT

The present invention provides a flexible electroacoustic apparatus. The flexible electroacoustic apparatus includes one or more flexible electroacoustic units. Each of the flexible electroacoustic units includes a flexible membrane and a flexible clamping assembly. The flexible membrane has a first surface and a second surface opposite to the first surface, and the flexible clamping assembly has two flexible clamping members disposed at the first surface and the second surface respectively for clamping the flexible membrane. A wearable electronic product capable of processing audio signals using the same is also provided.

### FIELD OF THE INVENTION

The present invention relates to an electroacoustic apparatus, and more particularly to a flexible electroacoustic apparatus and a wearable electronic product capable of processing audio signals using the same.

### BACKGROUND OF THE INVENTION

Technological advancements have led to the extensive application of portable electronic devices such as tablet computers and smart phones that are thinner and lighter than typical laptop computers. Upon the popularization of tablets computer and smart phones, integrating wearable electronic devices with electronic accessories has been gaining increased attention.

Wearable electronic devices such as smart watches and smart bracelets are typically compact in size and light in weight, so that users may wear these devices with ease. However, functions of wearable electronic devices have to be limited in order to satisfy the size and weight demands. For example, smart watches have all their electronic components disposed inside of the watch cases; however, the limited space available in a watch case limits the specifications of all of the electronic components disposed therein. Taking audio signals processing for instance, as a speaker would have to be fit in to the restricted space in a watch case, existing wearable electronic devices typically have poorer acoustic performances, including low audio volume and poor audio quality.

### SUMMARY OF THE INVENTION

The present invention provides a flexible electroacoustic apparatus for allowing integration with bendable or bent devices or objects.

The present invention also provides a wearable electronic product having a flexible electroacoustic apparatus, thus becoming bendable or being made into a bent shape.

To achieve the aforementioned and other advantages, an embodiment of the present invention provides a flexible electroacoustic apparatus, which includes one or more flexible electroacoustic units. Each of the flexible electroacoustic units includes a flexible membrane and a flexible clamping assembly. The flexible membrane has a first surface and a second surface opposite to the first surface; and the flexible clamping assembly has two flexible clamping members disposed at the first surface and the second surface respectively for clamping the flexible membrane.

In an embodiment of the present invention, the flexible clamping members at least surround an edge of the first surface and the edge of the second surface.

In an embodiment of the present invention, the flexible clamping members are comprised of a plurality of connecting hollow cylinders for clamping the flexible membrane.

In an embodiment of the present invention, the flexible clamping members are of a meshed structure.

In an embodiment of the present invention, the flexible clamping members are made of conductive materials.

In an embodiment of the present invention, the flexible clamping members are made of non-conductive materials.

In an embodiment of the present invention, each of the flexible electroacoustic units further comprises a conductive member, electrically connected to the flexible membrane.

In an embodiment of the present invention, the flexible membrane is a flexible piezoelectric membrane.

In an embodiment of the present invention, each of the flexible electroacoustic units further comprises a covering member, for covering the flexible membrane and the flexible clamping assembly.

In an embodiment of the present invention, the covering member and the flexible clamping assembly are monolithic.

In an embodiment of the present invention, the flexible electroacoustic apparatus further includes a control unit, electrically connected to each of the flexible electroacoustic units, for controlling each of the flexible electroacoustic units to act as at least one of an audio emission unit, an audio reception unit, and a force touch unit.

In an embodiment of the present invention, the flexible electroacoustic units, when acting as the audio emission unit, the audio reception unit, and the force touch unit simultaneously, receive instructions from the control unit to perform function switching and operations, or receive external audio signals or force touches to perform function switching and operations.

In an embodiment of the present invention, the flexible electroacoustic unit acting as the force touch unit is configured to control the flexible eletroacoustic apparatus.

In an embodiment of the present invention, the one or more flexible electroacoustic units are a plurality of flexible electroacoustic units, the control unit controls at least two of the plurality of flexible electroacoustic units to act as audio emission units, and the audio emission units are configured to emit different audio frequencies.

In an embodiment of the present invention, the one or more flexible electroacoustic units are a plurality of flexible electroacoustic units, and the control unit controls the number of the plurality of flexible electroacoustic units acting as audio emission units that are being switched on to adjust audio volume.

In an embodiment of the present invention, the one or more flexible electroacoustic units are a plurality of flexible electroacoustic units, and the control unit controls the plurality of flexible electroacoustic units to process multichannel audio signals.

Another embodiment of the present invention provides a wearable electronic product capable of processing audio signals, which includes a wearable device and the aforementioned flexible electroacoustic apparatus, secured on the wearable device.

In an embodiment of the present invention, the wearable electronic product further includes a wireless transception unit electrically connected to the flexible electroacoustic apparatus, for transceiving signals to allow the flexible electroacoustic apparatus to interact with an external device.

In an embodiment of the present invention, the wearable electronic product further includes at least one of an environmental sensing unit and a physiological sensing unit, electrically connected to the flexible electroacoustic apparatus, for allowing a sensing signals to interact with the flexible electroacoustic apparatus.

As the flexible electroacoustic units of the flexible electroacoustic apparatus according to the embodiments of the present invention include a flexible membrane and a flexible clamping assembly, the flexible electroacoustic apparatus is thus become bendable or can be made into a bent shape, allowing integration of the apparatus with flexible or bent devices or objects. When integrating with a smart watch, the flexible electroacoustic apparatus can be disposed within the watch band, providing a space-efficient solution to the existing problems. Furthermore, as the wearable electronic products capable of processing audio signals according the embodiments of the present invention adopt the aforementioned flexible electroacoustic apparatus, the wearable electronic products can become bendable or be made into a bent shape.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a schematic illustration of a flexible electroacoustic apparatus according to an embodiment of the present invention;

FIG. 2 is a schematic top view of the flexible electroacoustic unit according to FIG. 1;

FIG. 3 is a schematic top view of the flexible electroacoustic unit of the flexible electroacoustic apparatus according to another embodiment of the present invention;

FIG. 4 is a schematic illustration of the flexible electroacoustic unit of the flexible electroacoustic apparatus according to yet another embodiment of the present invention;

FIG. 5 is a schematic illustration of a flexible electroacoustic apparatus according to still another embodiment of the present invention;

FIG. 6 is a schematic illustration of a flexible electroacoustic unit of a flexible electroacoustic apparatus according to yet still another embodiment of the present invention;

FIG. 7 is a schematic illustration of a flexible electroacoustic apparatus according to yet still another embodiment of the present invention;

FIG. 8 is a schematic illustration of a wearable electronic product capable of processing audio signals according to an embodiment of the present invention;

FIG. 9 is a schematic illustration of a wearable electronic product capable of processing audio signals according to another embodiment of the present invention; and

FIG. 10 is a schematic illustration of a wearable electronic product capable of processing audio signals according to yet another embodiment of the present invention.

### DETAILED DESCRIPTION OF PREFERRED EMBODIMENTS

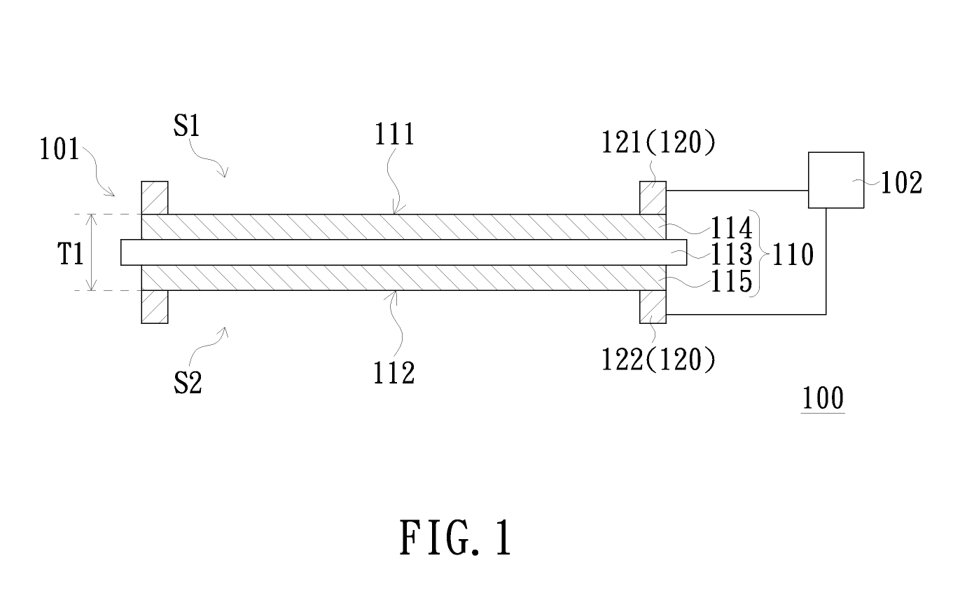

Referring now to FIG. 1, which illustrates a flexible electroacoustic apparatus according to an embodiment of the present invention. The flexible electroacoustic apparatus 100 includes one or more flexible electroacoustic unit 101; in FIG. 1, only one flexible electroacoustic unit 101 is shown for exemplary purposes. The flexible electroacoustic unit 101 includes a flexible membrane 110 and a flexible clamping assembly 120. The flexible membrane 110 has a first surface 111 and a second surface 112 opposite to the first surface 111, and the flexible clamping assembly 120 includes two flexible clamping members 121 and 122 disposed at the first surface 111 and the second surface 112, respectively, for clamping the flexible membrane 110 and forming cavities S1 and S2 with the first surface 111 and the second surface 112 of the flexible membrane 110, respectively.

In this embodiment, the flexible membrane 110 may be a flexible piezoelectric membrane, which includes a piezoelectric material layer 113 and metal layers 114 and 115 disposed on two sides of the piezoelectric material layer 113. The aforementioned first surface 111 and second surface 112 may be the surfaces of metal layers 114 and 115 away from the piezoelectric material layer 113. The metal layers 114 and 115 may be coatings formed on the two sides of the piezoelectric material layer 113. However, the flexible membrane 110 may be other types of membrane, and the present invention does not limit the types of the flexible membrane 110. Additionally, thickness T1 of the flexible membrane 110 may be, but is not limited to, 30 μm to 50 μm.

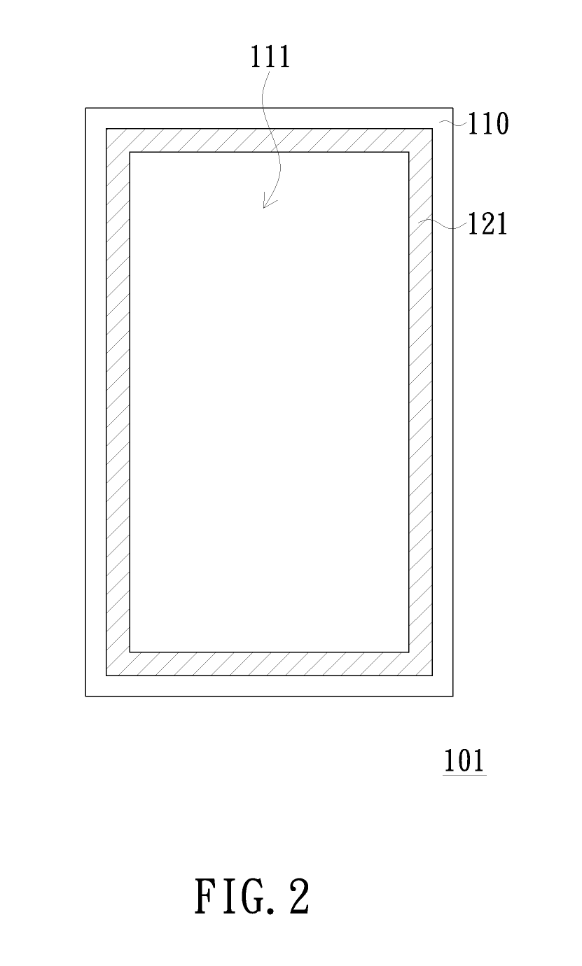

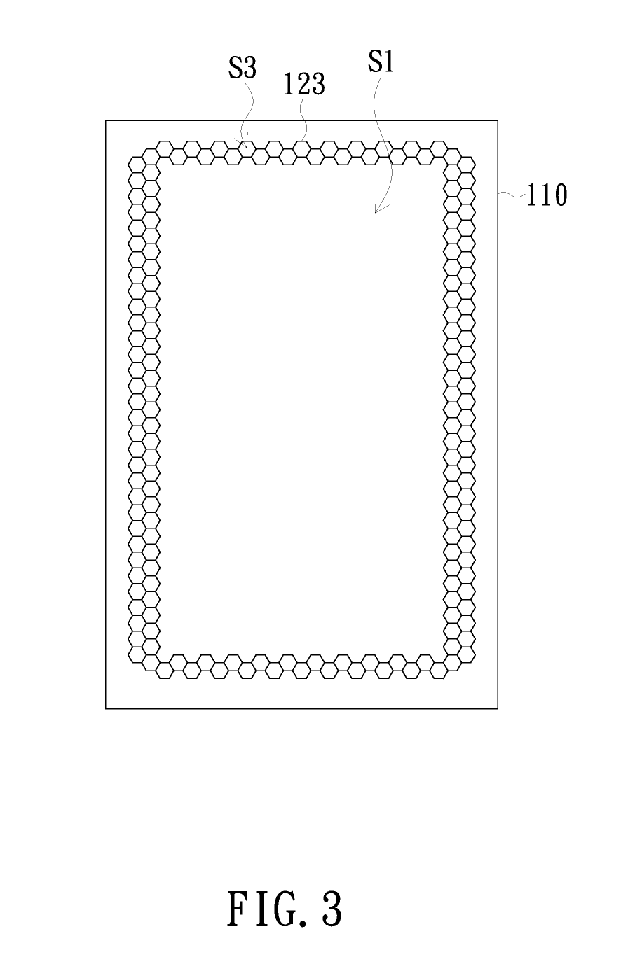

Referring now to both FIG. 1 and FIG. 2. FIG. 2 illustrates a top view of the flexible electroacoustic unit 101 according to FIG. 1. The flexible clamping members 121 and 122 may at least surround an edge of the first surface 111 and the edge of the second surface 112, and may also be comprised of a plurality of connecting hollow cylinders 123, as shown in FIG. 3, for clamping the flexible membrane 110. The hollow cylinders 123 may be disposed to stand on the flexible membrane 110. While the hollow cylinders 123 shown in FIG. 3 is hexagonal, the present invention does not limit the shape of the hollow cylinders 123; for example, the hollow cylinders 123 may also be circular or rectangular. The hollow cylinders 123 can form a plurality of small cavities S3 smaller than cavities S1 and S2, for improving the efficiencies of audio reception or emission.

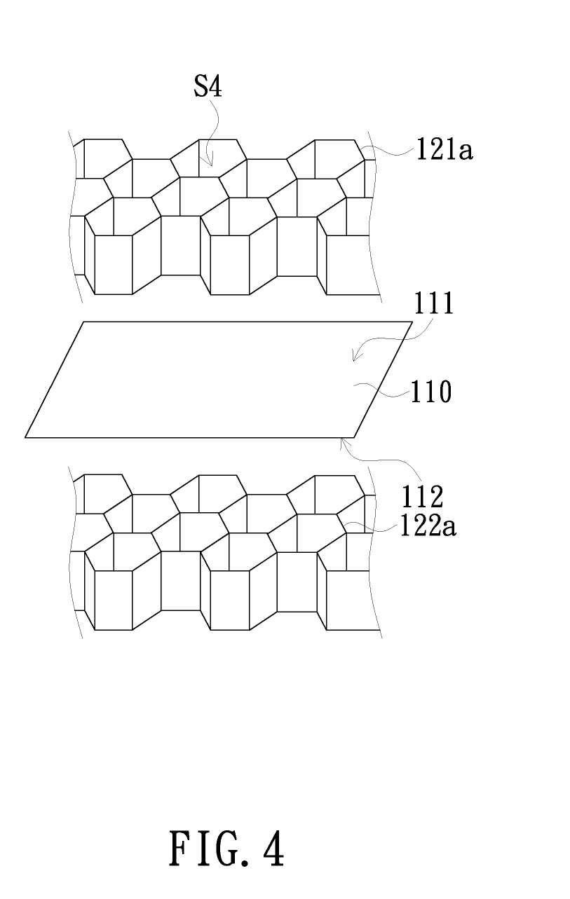

While the flexible clamping members 121 and 122 are disposed to surround the edge of the first surface 111 and the edge of the second surface 112 in this embodiment, the flexible clamping members 121 and 122 may also be disposed to align approximately with the entire first surface 111 and second surface 112 in other embodiments. In another embodiment illustrated in FIG. 4, the flexible clamping members 121a and 122a may be of a meshed structure, approximately aligning with the entire first surface 111 and second surface 112. The meshed structure may be, but is not limited to, a beehive structure. The meshed structure can form a plurality of small cavities S4 smaller than cavities S1 and S2, for improving the efficiencies of audio reception or emission.

Referring again to FIG. 1, the flexible electroacoustic apparatus 100 may further comprise a control unit 102, electrically connected to each of the flexible electroacoustic units 101, for controlling each of the flexible electroacoustic units 101 to act as an audio emission unit, an audio reception unit, or a force touch unit. Each of the flexible electroacoustic units 101 may be adjusted to perform one function or a plurality of functions according to specific needs; for example, the control unit 102 may control a single flexible electroacoustic unit 101 to act as one or two of the audio emission unit, the audio reception unit, and the force touch unit, or to simultaneously act as the audio emission unit, the audio reception unit, and the force touch unit. For instance, when the flexible electroacoustic unit 101 acts as an audio emission unit, the control unit 102 would output audio signals, driving the flexible membrane 110 to vibrate and thus emit sound waves; when the flexible electroacoustic unit 101 acts as an audio reception unit, the control unit 102 would receive audio signals converted from sound waves that are transduced via vibration of the flexible membrane 110; and when the flexible electroacoustic unit 101 acts as a force touch unit, the control unit 102 would receive signals generated by a user pressing the flexible electroacoustic unit 101 and thus determine the operations of the user. When acting as audio emission unit, audio reception unit, and force touch unit simultaneously, the flexible electroacoustic unit 101 would receive instructions from the control unit 102 to perform function switching and operations, or receive external audio signals or force touches to perform function switching and operations.

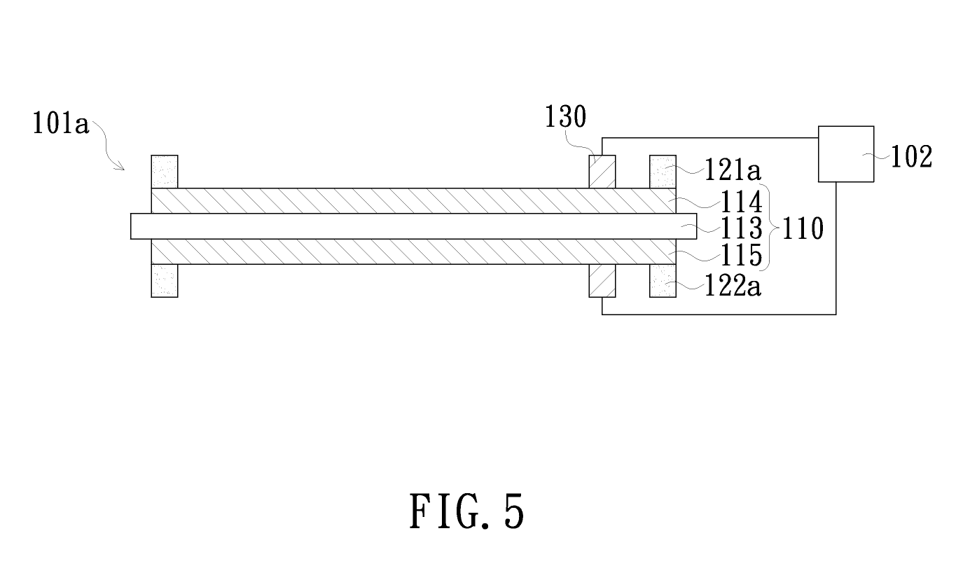

Furthermore, the flexible clamping members 121 and 122 may be made of conductive materials, and the flexible electroacoustic unit 101 may electrically connected to the control unit 102 via one of the flexible clamping members 121 and 122. In other embodiments, the flexible clamping members may also be made of non-conductive materials. In another embodiment shown in FIG. 5, the flexible clamping members 121a and 122a are made of non-conductive materials; and the flexible electroacoustic unit 101a further comprises a conductive member 130 connected to the flexible membrane 110, allowing the flexible membrane 110 to electrically connect to the control unit 102 via the conductive member 130.

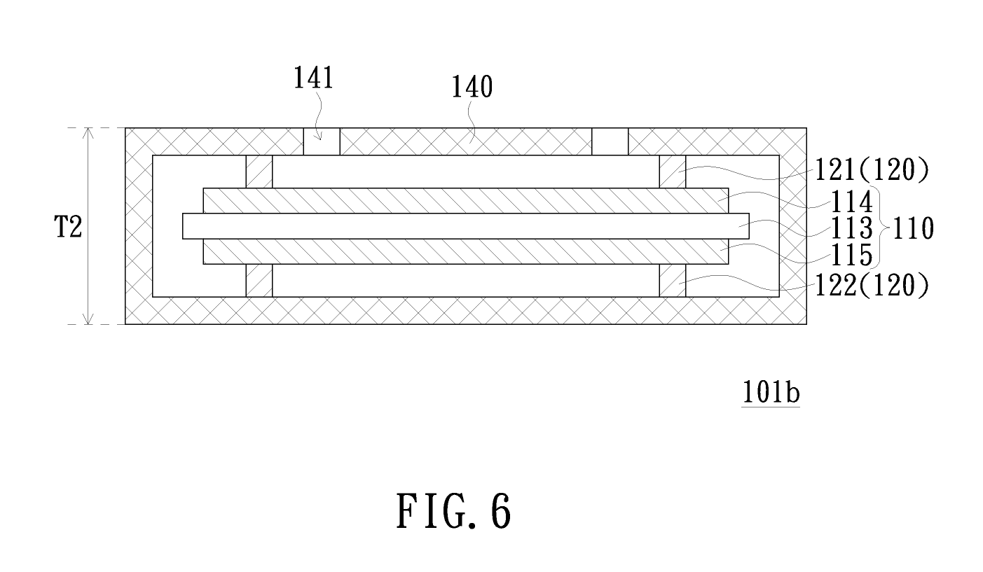

Referring now to FIG. 6, which illustrates a flexible electroacoustic unit of a flexible electroacoustic apparatus according to another embodiment of the present invention. The flexible electroacoustic unit 101b in this embodiment is similar to the flexible electroacoustic unit 101 illustrated in FIG. 1; this embodiment is different in that the flexible electroacoustic unit 101b further comprises a covering member 140 for covering the flexible membrane 110 and the flexible clamping assembly 120. The covering member 140 may, but is not limited to, be made of flexible materials such as plastics. The covering member 140 may include one or more openings 141 for allowing sound waves to pass through the covering member 140 or allowing wires (not shown in figure) for electrically connecting the flexible membrane 110 to the control unit 102 to pass through the covering member 140. In an embodiment, the covering member 140 and the flexible clamping assembly 120 are monolithic. Furthermore, thickness T2 of the flexible electroacoustic unit 101b may be, but is not limited to, a few micrometers; for example, 5 μm or 1 μm, or even smaller than 1 μm.

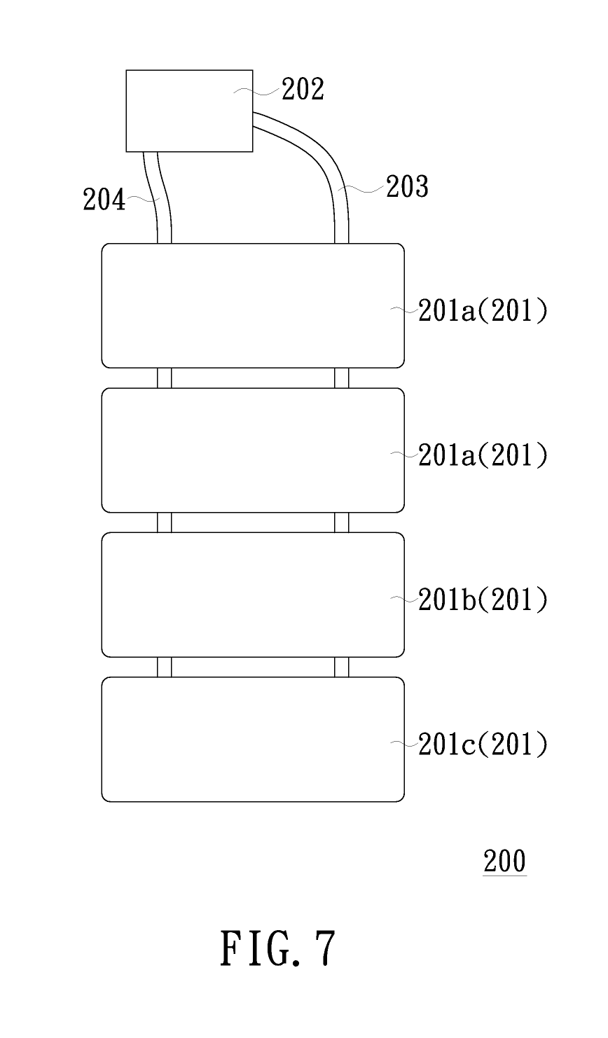

Referring now to FIG. 7, which illustrates a flexible electroacoustic apparatus according to another embodiment of the present invention. The flexible electroacoustic apparatus 200 includes a plurality of flexible electroacoustic units 201 and a control unit 202; the flexible electroacoustic units 201 may be any of the flexible electroacoustic units of the aforementioned embodiments. The flexible electroacoustic apparatus may further include wires 203 and 204, for electrically connecting the flexible electroacoustic units 201 to the control unit 202. It is to be understood that the number of wires demonstrated in this embodiment is merely exemplary; the number of wires to be used is not limited by the present invention, nor is the form of electrical connection between the flexible electroacoustic units 201 and the control unit 202. For example, the electrical connection may be established by utilizing electrical plugs and connectors. Additionally, arrangement of the flexible electroacoustic units 201 may be, but is not limited to, linear as exemplified in FIG. 7; and may be adjusted according to specific needs.

In this embodiment, the control unit 202 may control a portion of the flexible electroacoustic units 201 (such as flexible electroacoustic unit 201a) to act as an audio emission unit, another portion of the flexible electroacoustic units 201 (such as the flexible electroacoustic unit 201b) to act as an audio reception unit, and yet another portion of the flexible electroacoustic units 201 (such as the flexible electroacoustic unit 201c) to act as an force touch unit. In this way, the flexible electroacoustic apparatus 200 would possess functions of a microphone and an amplifier, and the user may operate the flexible electroacoustic apparatus 200, such as adjust audio volume or sensitivity of audio reception, via the flexible electroacoustic unit 201c acting as a force control unit. The control unit 202 may control the number of flexible electroacoustic unit 201a that are being switched on to adjust audio volume. Additionally, while the number of flexible electroacoustic unit 201b acting as an audio reception unit is merely one in this embodiment, the number may be plural; the control unit 202 may control the number of flexible electroacoustic units 201b that are being switched on to adjust the sensitivity of audio reception. Likewise, while the number of flexible electroacoustic unit 201c acting as a force touch unit is merely one in this embodiment, the number may also be plural, so that the user may operate various functions. Moreover, the control unit 202 may also control the flexible electroacoustic units 201 to possess an identical function; for example, all flexible electroacoustic units 201 acting as audio emission units.

It is to be understood that the control unit 202 may alter the function of each of the flexible electroacoustic units according to specific needs. When the user desires higher audio volume and does not need a microphone function, flexible electroacoustic unit 201b acting as an audio reception unit may be switched to become flexible electroacoustic unit 201a acting as an audio emission unit. Furthermore, in other embodiments in which a plurality of audio emission units are present, the audio emission units may be configured to emit different audio frequencies, such as treble, tenor, and bass; and the control unit 202 may output treble signals, tenor signals, and bass signals to control the audio emission units, respectively. A variety of means are available to enable the audio emission units to emit different audio frequencies; for example, by adjusting the shape or size of the flexible clamping members, or by techniques known to a person of ordinary skill in the art; the techniques are not repeated in details herein. In another embodiment, the control unit 202 may output different audio signals to different audio emission units, so as to provide a multichannel play function. In other embodiments, the control unit 202 may also control different audio reception units to receive different audio signals, thus to provide a multichannel reception function.

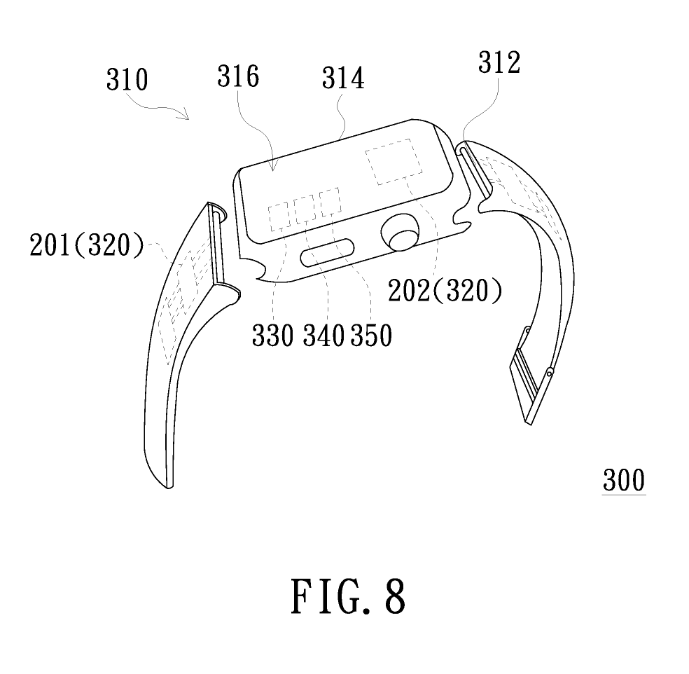

Referring now to FIG. 8, which illustrates a wearable electronic product capable of processing audio signals according to an embodiment of the present invention. The wearable electronic product capable of processing audio signals 300 includes a wearable device 310 and a flexible electroacoustic apparatus 320 secured on the wearable device 310. Although arranged differently, flexible electroacoustic apparatus 320 also includes flexible electroacoustic units 201 and a control unit 202 that are similar to the aforementioned flexible electroacoustic apparatus 200. In this exemplary embodiment, the wearable device 310 is a smart watch, the flexible electroacoustic unit 201 is disposed within a watch band 312 of the wearable device 310, and the control unit 202 is disposed within the watch case 314 of the wearable device 310. The watch band 312 is an add-on part of the watch case 314; and the control unit 202 controls a portion of the flexible electroacoustic units 201 to act as audio emission units, and another portion of the flexible electroacoustic units 201 to act as audio reception units. As the flexible electroacoustic units 201 are flexible and expandable (upon adjustment according to specific needs), the flexible electroacoustic units 201 are suitable for flexible devices or objects, such as watch bands 312. The flexible electroacoustic units 201 may be entirely covered by the watch band 312; and may be, but is not limited to, made of rubber, silicone, or leather.

The wearable electronic product 300 may include a display unit 316 for displaying images and allowing operations at a human-machine interface.

In an embodiment, the wearable electronic product 300 may include a wireless transception unit 330, such as but not limited to WiFi™ or Bluetooth™. The wireless transception unit 330 may be disposed within the watch case 314 or the watch band 312, and electrically connected with the control unit 202 directly or indirectly. The wireless transception unit 330 is configured to transceive signals to allow the flexible electroacoustic units 201 to interact with external devices; for example, the wireless transception unit 330 may transmit audio signals and play or receive the audio signals through the flexible electroacoustic units 201. The wireless transception unit may also transceive signals and/or instructions for allowing the wearable electronic product 300 adopting the flexible and expandable electroacoustic apparatus 320 of the present embodiment to interact with external devices; for example, signals and/or instructions of the flexible electroacoustic units 201 acting as force touch units may be transmitted via the wireless transception unit 330 to allow interaction with external devices. The external devices may include, but are not limited to, a cell phone, a smart device, a computer, a speaker, a player, a phone, a smart appliance, or an onboard unit that can interact with electronic devices by transceiving signals via electrical connection or via wireless communication.

The wearable electronic product 300 may further includes an environmental sensing unit 340 and a physiological sensing unit 350 electrically connected to the flexible electroacoustic apparatus 201 for allowing sensing signals to interact with the flexible electroacoustic apparatus 201. The environmental sensing unit 340 may be configured to sense the audio volume of the environment and automatically adjust the volume or reception sensitivity of the flexible electroacoustic apparatus 201 accordingly. The physiological sensing unit 350 may be configured to sense the physiological status of the user, such as heart rate, so as to determine if the user is conducting a static or dynamic activity, therefore providing automatic adjustment of the audio volume or reception sensitivity of the flexible electroacoustic apparatus 201 accordingly. It is to be understood that the environmental sensing unit 340 and the physiological sensing unit 350 are optional; in other embodiments, the wearable electronic product 300 may include only the environmental sensing unit 340 or only the physiological sensing unit 350.

In an embodiment, the wearable electronic product 300 may include a communication unit (not shown in figure) for communicating with the external devices. The communicating signals may be audio signals played out or received by the audio emission unit or the audio reception unit formed by the flexible electroacoustic units 201. The communication unit may be disposed within the watch case 314 or the watch band 312, and electrically connected with the control unit 202 directly or indirectly.

In an embodiment, the wearable electronic product 300 may include an external input unit (not shown in figure), such as but not limited to an actual keyboard, a touch keyboard, or a thermal sensing keyboard, for allowing operations at a human-machine interface.

In an embodiment, the wearable electronic product 300 may include a built-in battery unit (not shown in figure) for supplying power, or may electrically connect to an external device for power supply.

According to the aforementioned, wearable electronic product 300 adopting the flexible electroacoustic apparatus 320 according to the embodiments of the present invention may, but not limited to, be optionally added with functions of the control unit, an audio input unit, the wireless transception unit, the communication unit, the display unit, the external input unit, or the built-in battery unit according to specific needs.

The wearable electronic product 300 may also, but not limited to, be optionally added with functions of a satellite positioning unit, a temperature sensing unit, a pressure sensing unit, a heartbeat sensing unit, an acceleration sensing unit, a UV sensing unit, a solar energy storage unit, an environmental sensing unit, or a physiological sensing unit that can interact with functions of the flexible electroacoustic apparatus 320.

While the wearable electronic product capable of processing audio signals 300 is a smart watch in this exemplary embodiment, the wearable electronic product may also other smart devices, such as a smart wrist band, a smart bracelet, or a smart necklace. In other embodiments, the wearable electronic product 300 may, but is not limited to, be configured to play internal audio signals or interact with external devices to transceive audio signals. One of the main features of the flexible and expandable electroacoustic apparatus according to the embodiments of the present invention is that the audio emission unit and audio reception unit formed by the flexible and expandable apparatus may be disposed with any devices or objects demanded for flexibility or thin size with flexibility. The devices or objects are not limited to the aforementioned embodiments.

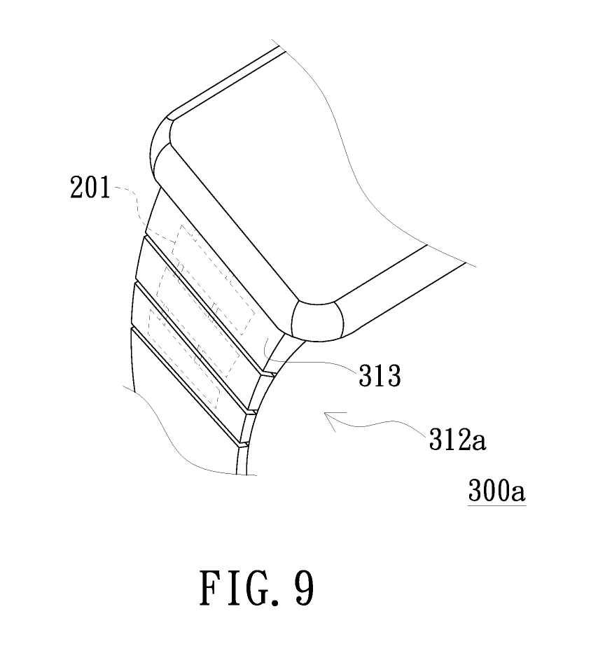

Referring now to FIG. 9, which illustrates a wearable electronic device capable of processing audio signals according to another embodiment of the present invention. The difference between the wearable electronic device capable of processing audio signals 300 of this embodiment and the wearable electronic device 300 in FIG. 8 lies in the watch band. More specifically, watch band 312a of the wearable electronic device capable of processing audio signals 300a is of a multi-sectional structure 313, similar to a typical metal watch band. At least a portion of the multi-sectional structure 313 is disposed with the flexible electroacoustic units 201.

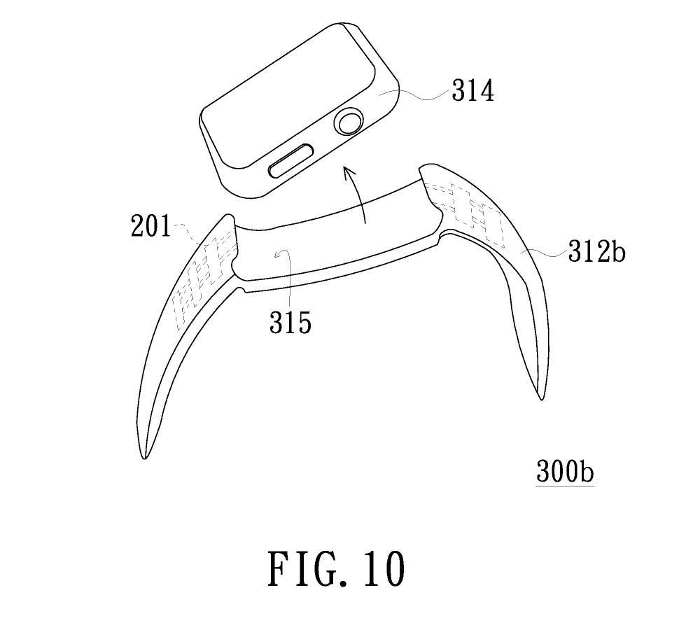

Referring now to FIG. 10, which illustrates a wearable electronic device capable of processing audio signals according to another embodiment of the present invention. The difference between the wearable electronic device capable of processing audio signals 300 of this embodiment and the wearable electronic device 300 in FIG. 8 lies in the watch band. More specifically, watch band 312b of the wearable electronic device capable of processing audio signals 300b includes a securing cell 315, in which the watch case 314 may be removably secured. The watch band 312b is disposed with the flexible electroacousitc units 201.

The wearable electronic products 300a and 300b may interact with external devices via electrical connection or wireless transmission according to the aforementioned embodiments. The wearable electronic products 300a and 300b may also, but are not limited to, be integrated into wrist bands, bracelets, and necklaces to form a smart device capable of playing internal audio signals or interacting with external devices to transceive audio signals.

In an embodiment, the flexible electroacoustic units 201 may be disposed within a circular wearable device, a bent wearable device, or any wearable devices of other shapes, to form wearable electronic products capable of processing audio signals, playing internal audio signals, electrically connecting with external devices, or interacting with external devices to transceive audio signals. However, the present invention is not limited thereto.

In sum, as the flexible electroacoustic units of the flexible electroacoustic apparatus according to the embodiments of the present invention include a flexible membrane and a flexible clamping assembly, the flexible electroacoustic apparatus is thus become bendable or can be made into a bent shape, allowing integration of the apparatus with flexible or bent devices or objects. When integrating with a smart watch, the flexible electroacoustic apparatus can be disposed within the watch band, providing a space-efficient solution to the existing problems. Furthermore, as the wearable electronic products capable of processing audio signals according the embodiments of the present invention adopt the aforementioned flexible electroacoustic apparatus, the wearable electronic products can be bendable or be made into a bent shape.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A flexible electroacoustic apparatus, comprising:
one or more flexible electroacoustic units, wherein each of the flexible electroacoustic units comprises:
a flexible membrane, having a first surface and a second surface opposite to the first surface; and
a flexible clamping assembly, having two flexible clamping members disposed at the first surface and the second surface respectively for clamping the flexible membrane.

2. The flexible electroacoustic apparatus according to claim 1, wherein the flexible clamping members at least surround an edge of the first surface and the edge of the second surface.

3. The flexible electroacoustic apparatus according to claim 2, wherein the flexible clamping members are comprised of a plurality of connecting hollow cylinders for clamping the flexible membrane.

4. The flexible electroacoustic apparatus according to claim 1, wherein the flexible clamping members are made of non-conductive materials.

5. The flexible electroacoustic apparatus according to claim 4, wherein each of the flexible electroacoustic units further comprises a conductive member, electrically connected to the flexible membrane.

6. The flexible electroacoustic apparatus according to claim 1, further comprising a control unit, electrically connected to each of the flexible electroacoustic units, for controlling each of the flexible electroacoustic units to act as at least one of an audio emission unit, an audio reception unit, and a force touch unit, wherein the flexible electroacoustic units acting as the force touch unit are configured to control the flexible electroacoustic apparatus.

7. The flexible electroacoustic apparatus according to claim 6, wherein the flexible electroacoustic units, when acting as the audio emission unit, the audio reception unit, and the force touch unit simultaneously, receive instructions from the control unit to perform function switching and operations, or receive external audio signals or force touches to perform function switching and operations.

8. The flexible electroacoustic apparatus according to claim 6, wherein the one or more flexible electroacoustic units are a plurality of flexible electroacoustic units, and the control unit controls the number of the plurality of flexible electroacoustic units acting as audio emission units that are being switched on to adjust audio volume.

9. The flexible electroacoustic apparatus according to claim 6, wherein the one or more flexible electroacoustic units are a plurality of flexible electroacoustic units, and the control unit controls the plurality of flexible electroacoustic units to process multichannel audio signals.

10. A wearable electronic product capable of processing audio signals, comprising:
a wearable device; and
a flexible electroacoustic apparatus, secured on the wearable device, the flexible electroacoustic apparatus comprising one or more flexible electroacoustic units, each of the flexible electroacoustic units comprising a flexible membrane and a flexible clamping assembly, wherein the flexible membrane has a first surface and a second surface opposite to the first surface, and the flexible clamping assembly has two flexible clamping members disposed at the first surface and the second surface respectively for clamping the flexible membrane.

11. The wearable electronic product capable of processing audio signals according to claim 10, wherein the flexible clamping members at least surround an edge of the first surface and the edge of the second surface.

12. The wearable electronic product capable of processing audio signals according to claim 11, wherein the flexible clamping members are comprised of a plurality of connecting hollow cylinders for clamping the flexible membrane.

13. The wearable electronic product capable of processing audio signals according to claim 10, wherein the flexible clamping members are made of non-conductive materials.

14. The wearable electronic product capable of processing audio signals according to claim 13, wherein each of the flexible electroacoustic units further comprises a conductive member, electrically connected to the flexible membrane.

15. The wearable electronic product capable of processing audio signals according to claim 10, wherein the flexible electroacoustic apparatus further comprises a control unit, electrically connected to each of the flexible electroacoustic units, for controlling each of the flexible electroacoustic units to act as at least one of an audio emission unit, an audio reception unit, and a force touch unit, wherein the flexible electroacoustic units acting as the force touch unit are configured to control the wearable electronic product.

16. The wearable electronic product capable of processing audio signals according to claim 15, wherein the flexible electroacoustic units, when acting as the audio emission unit, the audio reception unit, and the force touch unit simultaneously, receive instructions from the control unit to perform function switching and operations, or receive external audio signals or force touches to perform function switching and operations.

17. The wearable electronic product capable of processing audio signals according to claim 15, wherein the one or more flexible electroacoustic units are a plurality of flexible electroacoustic units, and the control unit controls the number of the plurality of flexible electroacoustic units acting as audio emission units that are being switched on to adjust audio volume.

18. The wearable electronic product capable of processing audio signals according to claim 15, wherein the one or more flexible electroacoustic units are a plurality of flexible electroacoustic units, and the control unit controls the plurality of flexible electroacoustic units to process multichannel audio signals.

19. The wearable electronic product capable of processing audio signals according to claim 10, further comprising:
a wireless transception unit, electrically connected to the flexible electroacoustic apparatus, for transceiving signals to allow the flexible electroacoustic apparatus to interact with an external device.

20. The wearable electronic product capable of processing audio signals according to claim 10, further comprising:
at least one of an environmental sensing unit and a physiological sensing unit, electrically connected to the flexible electroacoustic apparatus, for allowing a sensing signals to interact with the flexible electroacoustic apparatus.
